(19) United States
(12) Patent Application Publication
(10) Pub. No.: US 2026/0225933 A1
(43) Pub. Date: Aug. 6, 2026

(54) CONTROL DEVICE, CONTROL METHOD, AND CONTROL PROGRAM

(71) Applicant: Yokogawa Electric Corporation, Tokyo (JP)

(72) Inventors: Yasuhiro MATSUI, Tokyo (JP); Junji KAMIGUCHI, Tokyo (JP)

(21) Appl. No.: 19/159,933

(22) PCT Filed: Feb. 29, 2024
(86) PCT No.: PCT/JP2024/007575

§ 371 Date: Aug. 26, 2025

(30) Foreign Application Priority Data
Mar. 3, 2023 (JP) 2023-033038

(51) Int. Cl. C02F 5/08; C02F 1/44

(52) U.S. Cl. CPC C02F 5/08; C02F 1/441; C02F 2209/005; C02F 2209/02; C02F 2209/05; C02F 2303/22

(57) ABSTRACT

A control device includes an obtaining unit and a control unit. The obtaining unit obtains the physical quantities of a pump which is meant for pumping the treatment water into a reverse osmosis membrane device. The control unit controls the dosing of chemicals into the treatment water according the physical quantities of the pump.

### TECHNICAL FIELD

The present invention relates to a control device, a control method, and a control program.

### BACKGROUND ART

Conventionally, a water treatment system is known in which the treatment water is cleaned using a membrane filtration device that includes filtration membranes. In a water treatment system in which a membrane filtration device is used, the treatment water can be stably cleaned to a high quality.

On the other hand, in a water treatment system in which a membrane filtration device is used, the impurity present in the water gets deposited on the surface of the membranes, and it sometimes results in membrane clogging. In order to get rid of such membrane clogging, the membrane filtration device is cleaned on a periodic basis.

Conventionally, a device is known that predicts the membrane resistance value of the filtration membranes and controls the cleaning of the membrane filtration device according to the membrane resistance value. In this device, the actual value of membrane resistance is calculated from the values measured by a manometer, a flowmeter, and a water temperature gauge; and the cleaning is controlled according to the calculated actual value of membrane resistance.

### CITATION LIST

### Patent Literature

PTL 1: Japanese Laid-open Patent Publication No. 2020-104093

### SUMMARY OF INVENTION

### Technical Problem

For example, in a membrane filtration device in which an RO (Reverse Osmosis) membrane is used (i.e., in a reverse osmosis membrane device), in addition to cleaning the membranes on a periodic basis, chemicals (such as a scale preventive agent (anti-scalant) and an organism propagation preventive agent (a biocide) are added with the aim of preventing membrane clogging (blockage).

Generally, such chemicals are added on a continuous basis to the feed water supplied to the RO membranes. However, since the chemicals have a high cost and are added to the feed water on a continuous basis, they contribute to an increase in the operation cost. For that reason, there is a demand for optimizing the addition of chemicals to the RO membranes and holding down the operation cost.

As an aspect, it is an objective to control the addition of chemicals into a reverse osmosis membrane device in a more appropriate manner.

### Solution to Problem

A control device according to an aspect includes an obtaining unit and a control unit. The obtaining unit obtains the physical quantities of a pump which is meant for pumping the treatment water into a reverse osmosis membrane device. The control unit controls the dosing of chemicals into the treatment water according the physical quantities of the pump.

### Advantageous Effects of Invention

According to an embodiment, the chemicals added into a reverse osmosis membrane device can be controlled in a more appropriate manner.

### BRIEF DESCRIPTION OF DRAWINGS

FIG. 1 is a diagram illustrating an example of a control operation performed according to an embodiment.

FIG. 2 is a diagram illustrating an exemplary configuration of a reverse osmosis membrane device according to the present embodiment.

FIG. 3 is a block diagram illustrating an exemplary configuration of a control device according to the present embodiment.

FIG. 4 is a diagram for explaining an example of a control operation performed according to the present embodiment.

FIG. 5 is a diagram for explaining another example of the control operation performed according to the present embodiment.

FIG. 6 is a diagram for explaining another example of the control operation according to the present embodiment.

FIG. 7 is a flowchart for explaining an exemplary flow of the control operation performed according to the present embodiment.

FIG. 8 is a diagram for explaining an exemplary hardware configuration of the control device.

### DESCRIPTION OF EMBODIMENTS

An exemplary embodiment of a control device, a control method, and a control program according to the application concerned is described in detail below with reference to the accompanying drawings. However, the invention according to the application concerned is not limited by the embodiment described below.

The identical constituent elements are referred to by the same reference numerals, and their explanation is not repeated. Moreover, if a plurality of identical elements needs to be differentiated from each other, sometimes number symbols are posteriorly attached to the same reference numeral as a way to differentiate the elements. On the other hand, when a plurality of identical elements need not be differentiated from each other, the same reference numeral is used as it is. For example, pumps representing identical constituent elements can be differentiated by referring to them as a “first pump 121_1” and a “second pump 121_2”. On the other hand, when the “first pump 121_1” and the “second pump 121_2” need not be particularly differentiated from each other, they are simply referred to as “pumps 121”.

Meanwhile, embodiments can be appropriately combined together without causing any contractions.

### 1. To Begin With

### 1.1. Problem

The water treatment of drainage water, such as sewage water or rainwater, is generally classified into three main types of treatment, namely, primary treatment, secondary treatment, and tertiary treatment.

In the primary treatment, large solid objects such as foreign substances are removed from the drainage water. In the secondary treatment, the organic substances that could not be removed in the primary treatment are removed using microorganisms (bacteria). In the secondary treatment, for example, activated sludge treatment and nitrification denitrification reaction treatment is performed. In the tertiary treatment, free-floating solid objects that could not be removed in the secondary treatment are removed by precipitation. In the tertiary treatment, for example, membrane filtration treatment is used to remove the free-floating solid objects.

In the membrane filtration treatment performed during the secondary treatment, two main types of filtration membranes are used. One on hand, membrane filtration treatment is performed using an MF membrane (MicroFiltration membrane) or a UF membrane (UltraFiltration membrane). On the other hand, membrane filtration treatment is performed using an RO membrane (Reverse Osmosis membrane) (hereinafter, also written as RO membrane treatment).

Although explained later in detail, in the RO membrane treatment, membrane filtration treatment is performed in three main stages. In each stage, the feed water is separated into permeable water and concentrated water due to an RO membrane. The permeable water is treated as the post-membrane-filtration-treatment RO membrane permeable water and is subjected to subsequent treatment (for example, UV treatment). The concentrated water is supplied to the next stage and is subjected to membrane filtration treatment using an RO membrane. In the last stage, the concentrated water is discharged as the concentrated discharge to the outside of the water treatment system.

In the RO membrane treatment, in addition to cleaning the membranes on a periodic basis, it is standard practice to continuously add chemicals to the feed water supplied to the RO membranes. Examples of the chemicals include a scale preventive agent (anti-scalant) and an organism propagation preventive agent (a biocide) that are aimed at preventing blockage of the RO membranes.

As explained above, the RO membrane treatment is divided into three stages, and filtration using an RO membrane is performed in each stage. The feed water supplied to each stage represents the concentrated water obtained in the previous stage. For that reason, the water quality of the concentrated water supplied to each stage is significantly different. For example, in the third stage, the concentrated water has about five times higher concentration than the concentration in the first stage. Accordingly, in each stage, the chemicals used are also different. For example, in the first stage, chemicals (such as an anti-scalant or a biocide) are used for killing the microorganisms; and, in the third stage, acidic chemicals (such as sulfuric acid) are used.

Generally, the dosage of such chemicals is controlled using AI. These chemicals prevent clogging (blockage) of the RO membranes, and are thus used to prolong the period of use of the RO membranes. However, these chemicals are expensive, and an increase in the usage of such chemicals contributes to an increase in the operation cost.

For that reason, there is a demand for managing the usage of the chemicals in an appropriate manner.

Meanwhile, in a water treatment process in which drainage water, such as sewage water or rainwater, is recycled into drinking water, mainly the following operations are performed: membrane filtration treatment using an MF membrane or a UF membrane; RO membrane treatment; and UV-AOP (Advanced Oxidation Process using UV rays). At that time, treatment water that regularly contains chloramine equal to or smaller than 3 mg/L in concentration is supplied to the RO membranes. There have been reports indicating that the chloramine concentration of 3 mg/L and the fact that chloramine is added on a regular basis is associated to an increase in the cost of the chemicals such as sodium hypochlorite and associated to the damage of the RO membranes made of an aromatic polyamide material.

### 1.2. Overview of Control Operation

In that regard, in the present embodiment, a control device configured to control the water treatment obtains the physical quantities of the pumps meant for pumping the treatment water into an RO membrane filtration device and, according to the physical quantities of the pumps, controls the dosing of chemicals (for example, an anti-scalant) into the treatment water. For example, as far as the chemical dosing control is concerned, the control device controls the dosing timing and the dosage of the chemicals.

As a result, the control device becomes able to perform more appropriate chemical dosing control. Thus, the control device enables achieving further reduction in the cost of chemicals and prolonging the usage of the RO membrane.

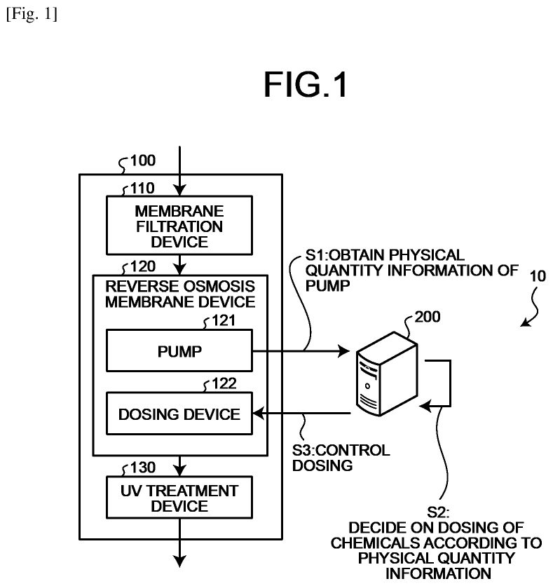

Explained below with reference to FIG. 1 is an example of a control operation performed by the control device.

FIG. 1 is a diagram illustrating an example of a control operation performed according to the present embodiment. A water treatment system 10 illustrated in FIG. 1 includes a water treatment device 100 and a control device 200. The water treatment device 100 recycles drainage water, such as sewage water or rainwater, into daily life water or drinking water.

The water treatment device 100 is supplied with, for example, treatment water obtained by performing the activated sludge treatment and the nitrification denitrification reaction treatment on drainage water (i.e., treatment water subjected to the primary treatment and the secondary treatment). Then, the water treatment device 100 performs membrane treatment on the treatment water supplied thereto. That is, the water treatment device 100 mainly performs the tertiary treatment explained earlier.

After being treated in the water treatment device 100, the treatment water is disinfected using, for example, chlorine and is used as daily life water or drinking water.

The activated sludge treatment and the nitrification denitrification reaction treatment are performed in, for example, a sewage water treatment facility. The water treatment device 100 performs membrane treatment on, for example, the drainage water that has been treated in a sewage water treatment facility.

The water treatment device 100 illustrated in FIG. 1 includes a membrane filtration device 110, a reverse osmosis membrane device 120, and an UV treatment device 130.

The membrane filtration device 110 removes microorganisms and particulate matter from the feed water using filtration membranes. The filtration membranes of the membrane filtration device 110 are, for example, an ultrafiltration membrane (UF membrane) and a microfiltration membrane (MF membrane).

The reverse osmosis membrane device 120 is supplied with the treatment water from the membrane filtration device 110. The reverse osmosis membrane device 120 removes impurity such as ions and salts from the feed water. The reverse osmosis membrane device 120 includes reverse osmosis membranes (RO membranes).

The reverse osmosis membrane device 120 illustrated in FIG. 1 includes pumps 121 and a dosing device 122. The pumps 121 supply the treatment water, which has been treated in the membrane filtration device 110, to the RO membranes. The dosing device 122 adds chemicals such as an anti-scalant into the feed water supplied to the RO membranes.

The UV treatment device 130 is supplied with the treatment water that has been treated in the reverse osmosis membrane device 120. The UV treatment device 130 performs UV-AOP (Advanced Oxidation Process using UV rays) with respect to the treatment water supplied thereto. As a result, the UV treatment device 130 causes oxidative decomposition of the trace chemical substances (for example, NDMA) present in the feed water.

The feed water supplied to the membrane filtration device 110 is also referred to as membrane filtration feed water. The feed water supplied to the reverse osmosis membrane device 120 is also referred to as reverse osmosis membrane feed water. The feed water supplied to the UV treatment device 130 is also referred to as UV feed water.

The control device 200 controls the constituent elements of the water treatment device 100. The control device 200 according to the present embodiment performs the control operation illustrated in FIG. 1.

In the control operation, firstly, the control device 200 obtains physical quantity information of the pumps 121 (Step S1). The physical quantity information of the pumps 121 is, for example, the physical quantities of the pumps 121 (for example, at least either the water quantity or the water pressure).

Then, according to the obtained physical quantity information, the control device 200 decides on the dosing of the chemicals (Step S2). For example, the control device 200 decides on the dosing method of the chemicals (the dosing timing and the dosage). For example, based on the physical quantity information, the control device 200 analyzes the changes in the physical quantities of the pumps 121 and analyzes the behavior of the pumps 121, and decides on the dosing method of the chemicals.

Based on the decided dosing method, the control device 200 controls the dosing of the chemicals (Step S3). For example, the control device 200 notifies the dosing device 122 about the decided dosing method and controls the dosing of the chemicals.

As a result, the water treatment device 100 can control, in a more appropriate manner, the chemicals to be added to the reverse osmosis membrane device 120.

### 2. Exemplary System Configuration

### 2.1. Exemplary Configuration of Reverse Osmosis Membrane Device

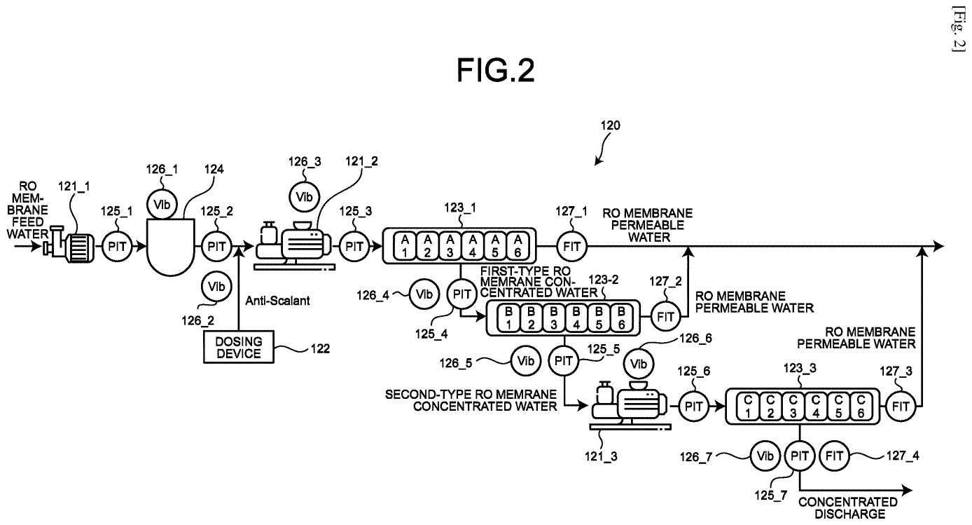

FIG. 2 is a diagram illustrating an exemplary configuration of the reverse osmosis membrane device 120 according to the present embodiment. The reverse osmosis membrane device 120 illustrated in FIG. 2 includes a first pump 121_1 to a third pump 121_3, a dosing device 122, a first RO membrane unit 123_1 to a third RO membrane unit 123_3, and a security filter 124. The reverse osmosis membrane device 120 further includes a first pressure sensor 125_1 to a seventh pressure sensor 125_7, a first vibration sensor 126_1 to a seventh vibration sensor 126_7, and a first flow rate sensor 127_1 to a fourth flow rate sensor 127_4.

### (RO Membrane Units 123)

The first RO membrane unit 123_1 includes RO membranes A1 to A6. The first RO membrane unit 123_1 is supplied with, for example, RO membrane feed water via the security filter 124. Then, using the RO membranes A1 to A6, the first RO membrane unit 123_1 separates the RO membrane feed water into RO membrane permeable water (RO membrane filtered water) and first-type RO membrane concentrated water. The first RO membrane unit 123_1 supplies the first-type RO membrane concentrated water to the second RO membrane unit 123_2. The membrane filtration treatment performed by the first RO membrane unit 123_1 is equivalent to the membrane filtration treatment performed in the first stage as explained earlier.

The second RO membrane unit 123_2 includes RO membranes B1 to B6. The second RO membrane unit 123_2 is supplied with, for example, the first-type RO membrane concentrated water from the first RO membrane unit 123_1. Then, using the RO membranes B1 to B6, the second RO membrane unit 123_2 separates the first-type RO membrane concentrated water into RO membrane permeable water and second-type RO membrane concentrated water. The second RO membrane unit 123_2 supplies the second-type RO membrane concentrated water to the third RO membrane unit 123_3. The membrane filtration treatment performed by the second RO membrane unit 123_2 is equivalent to the membrane filtration treatment performed in the second stage as explained earlier.

The third RO membrane unit 123_3 includes RO membranes C1 to C6. The third RO membrane unit 123_3 is supplied with, for example, the second-type RO membrane concentrated water from the second RO membrane unit 123_2. Then, using the RO membranes C1 to C6, the third RO membrane unit 123_3 separates the second-type RO membrane concentrated water into RO membrane permeable water and concentrated discharge. The third RO membrane unit 123_3 discharges the concentrated discharge to the outside of the water treatment device 100. The membrane filtration treatment performed by the third RO membrane unit 123_3 is equivalent to the membrane filtration treatment performed in the third stage as explained earlier.

The reverse osmosis membrane device 120 supplies the RO membrane permeable water to the UV treatment device 130 (see FIG. 1).

### (Pumps 121)

The first pump 121_1 is a feeder pump that feeds the RO membrane treatment water to the security filter 124. The second pump 121_2 is a high pressure pump (HPP) that feeds the RO membrane feed water, which has passed through the security filter 124, to the first RO membrane unit 123_1. The third pump 121_3 is a booster pump that feeds the second-type RO membrane concentrated water to the third RO membrane unit 123_3. Thus, using these pumps 121, the reverse osmosis membrane device 120 supplies the RO membrane feed water to the RO membrane units 123.

### (Dosing Device 122)

The dosing device 122 adds chemicals (for example, an anti-scalant) into the RO membrane feed water that has passed through the security filter 124. Herein, the explanation is given about an example in which the dosing device 122 adds chemicals in the latter part of the security filter 124. However, alternatively, the dosing device 122 can add chemicals in the early part of the security filter 124. Moreover, herein, the explanation is given about an example in which the dosing device 122 adds chemicals into the RO membrane feed water. However, alternatively, the dosing device 122 can add chemicals into the first-type RO concentrated water and the second-type RO concentrated water.

### (Security Filter 124)

The security filter 124 is a filter for removing microparticles present in the RO membrane feed water. Herein, in order to prevent damage to the RO membranes, the security filter 124 is disposed at an earlier stage than the first RO membrane unit 123_1.

### (Pressure Sensors 125)

The first pressure sensor 125_1 measures the pressure of the RO membrane feed water in the outflow portion of the first pump 121_1 (i.e., in the inflow portion of the security filter 124). The second pressure sensor 125_2 measures the pressure of the RO membrane feed water in the outflow portion of the security filter 124 (i.e., in the inflow portion of the second pump 121_2). The third pressure sensor 125_3 measures the pressure of the RO membrane feed water in the outflow portion of the second pump 121_2 (i.e., in the inflow portion of the first RO membrane unit 123_1).

The fourth pressure sensor 125_4 measures the pressure of the first-type RO membrane concentrated water in the outflow portion for the first-type RO membrane concentrated water in the first RO membrane unit 123_1 (in the inflow portion of the second RO membrane unit 123_2). The fifth pressure sensor 125_5 measures the pressure of the second-type RO membrane concentrated water in the outflow portion for the second-type RO membrane concentrated water in the second RO membrane unit 123_2 (i.e., in the inflow portion of the third pump 121_3).

The sixth pressure sensor 125_6 measures the pressure of the second-type RO membrane concentrated water in the outflow portion of the third pump 121_3 (i.e., the inflow portion of the third RO membrane unit 123_3). The seventh pressure sensor 125_7 measures the pressure of the concentrated discharge in the outflow portion for the concentrated discharge in the third RO membrane unit 123_3.

The pressure sensors 125 output the measurement result to the control device 200.

### (Vibration Sensors 126)

The first vibration sensor 126_1 measures the vibrations of the security filter 124. The second vibration sensor 126_2 measures the vibrations of the piping in the outflow portion of the security filter 124 (i.e., the inflow portion of the second pump 121_2) (i.e., measures the vibrations of the piping for the RO membrane feed water). The third vibration sensor 126_3 detects the vibrations of the second pump 121_2.

The fourth vibration sensor 126_4 measures the vibrations of the piping in the outflow portion of the first RO membrane concentrated water (i.e., the inflow portion of the second RO membrane unit 123_2) (i.e., measures the vibrations of the piping for the first-type RO membrane concentrated water). The fifth vibration sensor 126_5 measures the vibrations of the piping in the outflow portion for the second-type RO membrane concentrated water in the second RO membrane unit 123_2 (i.e., the inflow portion of the third pump 121_3) (i.e., measures the vibrations of the piping of the second-type RO membrane concentrated water).

The second-type vibration sensor 126_6 measures the vibrations of the piping in the outflow portion of the third pump 121_3 (i.e., the inflow portion of the third RO membrane unit 123_3) (i.e., measures the vibrations of the piping for the second RO membrane concentrated water). The seventh vibration sensor 126_7 measures the vibrations of the piping in the outflow portion for the concentrated discharge in the third RO membrane unit 123_3 (i.e., measures the vibrations of the piping for the concentrated discharge).

The vibration sensors 126 output the measurement result to the control device 200.

### (Flow Rate Sensors 127)

The first flow rate sensor 127_1 measures the flow rate per unit time of the RO membrane permeable water flowing out from the first RO membrane unit 123_1. The second flow rate sensor 127_2 measures the flow rate per unit time of the RO membrane permeable water flowing out from the second RO membrane unit 123_2.

The third flow rate sensor 127_3 measures the flow rate per unit time of the RO membrane permeable water flowing out from the third RO membrane unit 123_3. The fourth flow rate sensor 127_4 measures the flow rate per unit time of the concentrated discharge flowing out from the third RO membrane unit 123_3.

Meanwhile, the flow rate sensors 127 can also be configured to measure the water temperature of the RO membrane permeable water. Alternatively, a water temperature sensor (not illustrated) can be disposed along with the flow rate sensors 127 for measuring the water temperature of the RO membrane permeable water.

The flow rate sensors 127 output the measurement result to the control device 200.

Meanwhile, although not illustrated in FIG. 2, the reverse osmosis membrane device 120 can include an electricity conductivity meter. For example, the electricity conductivity meter can be disposed in each of the following: the piping for the RO membrane feed water supplied to the first RO membrane unit 123_1, the piping for the RO membrane permeable water, the piping for the first RO membrane concentrated water, and the piping for the second RO membrane concentrated water. Each electricity conductivity meter measures the electricity conductivity in the corresponding piping.

### 2.2. Exemplary Configuration of Control Device

As explained above, from each sensor, the control device 200 according to the present embodiment obtains physical quality information related to the physical quantities and water quality information related to the water quality of the second pump 121_2 and the third pump 121_3, which supply the RO membrane feed water to the RO membrane units 123, and the security filter 124.

For example, the control device 200 obtains, as the physical quantity information, information related to the physical quantities (the vibrations, the water quantity, and the water pressure) of the second pump 121_2, the third pump 121_3, and the security filter 124.

Moreover, for example, the control device 200 obtains, as the water quality information, information related to the water quality (the electricity conductivity and the water temperature) of the second pump 121_2, the third pump 121_3, and the security filter 124.

Based on the physical quantity information and the water quantity information that is obtained, the control device 200 analyzes the variation and the behavior of the physical quantities and the water quality. Based on the analysis result, the control device 200 controls the dosing method (the dosing timing and the dosage) of the chemicals.

In this way, according to the physical quantities (for example, the vibration, the water quantity, and the water pressure) of the pumps 121, the control device 200 according to the present embodiment optimizes the dosing of the chemicals (for example, an anti-scalant) meant for preventing blockage of the RO membranes. For example, the control device 200 optimizes the dosing by performing control with respect to the dosing timing and the concentration of the chemicals.

As a result, the control device 200 becomes able to perform the dosing control of the chemicals in an appropriate manner, thereby enabling achieving reduction in the cost of the chemicals and prolonging the life of the RO membranes.

Moreover, based on the physical quantity information and the water quality information that is obtained, the control device 200 predicts and detects the clogging condition (blockage condition) of the RO membranes. The control device 200 analyzes water quantity information related to the water quantity, analyzes water quality information related to the water quality, analyzes pressure information related to the pressure, and analyzes vibration information related to the vibrations; and predicts and detects the clogging condition (blockage condition) of the RO membranes.

Given below is the explanation of an exemplary configuration of the control device 200 that performs the operations explained above.

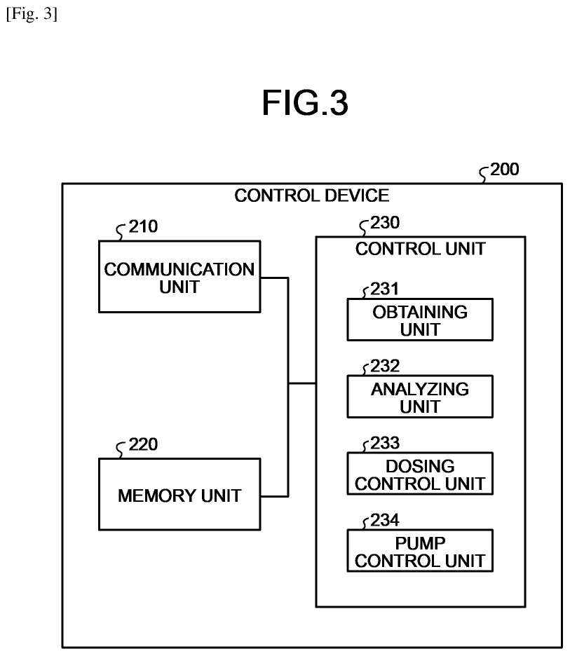

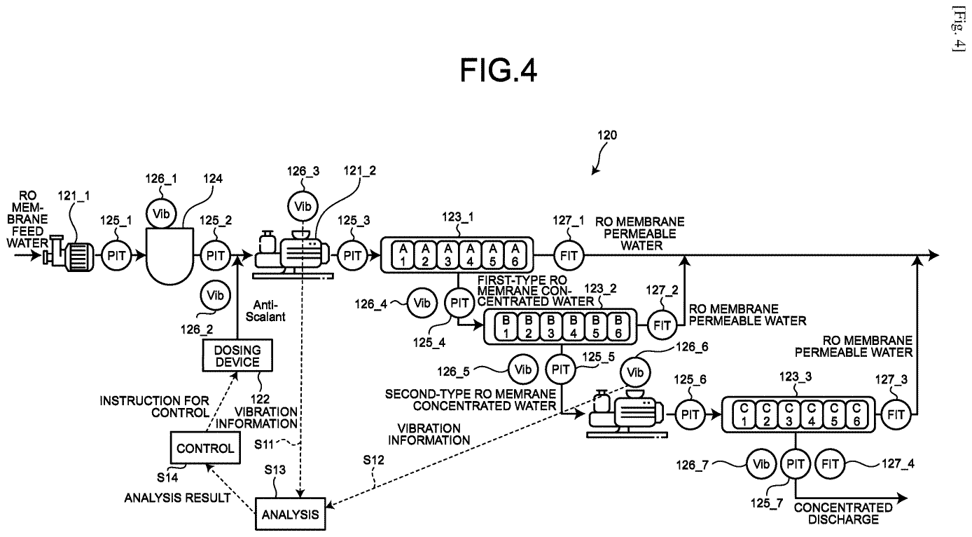

FIG. 3 is a block diagram illustrating an exemplary configuration of the control device 200 according to the present embodiment. The control device 200 illustrated in FIG. 4 includes a communication unit 210, a memory unit 220, and a control unit 230.

### (Communication Unit 210)

The communication unit 210 performs data communication with other devices. For example, the communication unit 210 performs communication with the devices included in the water treatment device 100.

### (Memory Unit 220)

The memory unit 220 is used to store a variety of information to be referred to by the control unit 230 at the time of performing operations, and to store a variety of information to be obtained by the control unit 230 at the time of performing operations. The memory unit 220 can be implemented, for example, using a semiconductor memory device such as a RAM (Random Access Memory) or a flash memory, or using a memory device such as a hard disk or an optical disc. In the example illustrated in FIG. 4, the memory unit 220 is installed inside the control device 200. Alternatively, the memory unit 220 can be installed on the outside of the control device 200, or a plurality of memory units can be installed.

### (Control Unit 230)

The control unit 230 controls the entire control device 200 and the water treatment device 100. The control unit 230 includes an obtaining unit 231, an analyzing unit 232, a dosing control unit 233, and a pump control unit 234. For example, the control unit 230 can be implemented using an electronic circuit such as a CPU (Central Processing Unit) or an MPU (Micro Processing Unit), or can be implemented using an integrated circuit such as an ASIC (Application Specific Integrated Circuit) or an FPGA (Field Programmable Gate Array).

### (Obtaining Unit 231)

The obtaining unit 231 obtains a variety of information from the water treatment device 100. The obtaining unit 231 obtains the measurement result from the pressure sensors 125 as the pressure information. Moreover, the obtaining unit 231 obtains the measurement result from the vibration sensor 126 as the vibration information. Furthermore, the obtaining unit 231 obtains the measurement result from the flow rate sensor 127 as the flow rate information. Then, the obtaining unit 231 outputs the variety of obtained information to the analyzing unit 232 and the pump control unit 234.

### (Analyzing Unit 232)

Based on the variety of information obtained by the obtaining unit 231, the analyzing unit 232 analyzes the blockage condition of the RO membranes. For example, the analyzing unit 232 predicts or detects the blockage condition of the RO membranes.

For example, based on the vibration information measured by the vibration sensors 126 corresponding to the security filter 124, the second pump 121_2, and the third pump 121_3; the analyzing unit 232 analyzes (for example, predicts and detects) the blockage condition of the RO membranes and the security filter 124.

In the present embodiment, the attention is focused on the vibrations caused by the surge occurring in the security filter 124, the second pump 121_2, and the third pump 121_3.

For example, it is believed that the blockage in the security filter 124 can be detected from the relationship between the frequency (the repeat count (Hz) per second per speed) and the transmission speed mm/sec in the vibrational wave state.

For example, in the case example about the vibration features of the piping, abnormal values based on the relationship between the frequency and the transmission speed are defined. That definition is applied to the anomaly detection in the piping.

In the present embodiment, the case example about the vibration features is also applied to the blockages in the security filter 124 and the RO membranes. The analyzing unit 232 analyzes the frequency and the transmission speed from the vibration information, and analyzes (predicts and detects) the blockage condition of the security filter 124 and the RO membranes.

Meanwhile, the analyzing unit 232 can analyze the blockage condition of the RO membranes using the vibration information measured by the vibration sensor 126 disposed in the piping for the second RO membrane concentrated water. Meanwhile, the analyzing unit 232 can analyze the blockage condition of the RO membranes based on the vibrations of the piping in addition to (or in place of) referring to the vibrations of the security filter 124, the second pump 121_2, and the third pump 121_3.

Moreover, based on the measurement result (the pressure information) obtained by the pressure sensors 125 that are disposed in the piping for supplying the feed water to the RO membranes and in the piping for the first-type RO membrane concentrated water and the second-type RO membrane concentrated water, the analyzing unit 232 monitors and analyzes a percentage rise delta P in the pressure accompanying the blockage of the RO membranes.

Meanwhile, the rated water quantity for the RO membranes is set in advance in the design stage. Hence, when an RO membrane gets blocked, in order to maintain the water quantity in the reverse osmosis membrane device 120 at the rated water quantity, the driving pressure of the pumps 121 increases. The analyzing unit 232 refers to the pressure information and analyzes the blockage condition of the RO membrane.

Moreover, based on the measurement result (the flow rate information) obtained by the flow rate sensors 127 that are disposed in the piping for the RO membrane feed water, the piping for the RO membrane permeable water, and the piping for the first-type RO membrane concentrated water and the second-type RO membrane concentrated water, the analyzing unit 232 monitors and analyzes the quantity (material balance) of the fluid in the entire reverse osmosis membrane device 120. Herein, the material balance represents the difference obtained by temporally accumulating the inflow quantity and the outflow quantity.

For example, the analyzing unit 232 monitors and analyzes the displacement and the membrane permeability of the permeable water in the first RO membrane unit 123_1 to the third RO membrane unit 123_3. The membrane permeability is evaluated using the driving pressure meant for maintaining a predetermined fluid velocity. The fluid velocity represents the flow rate per unit area. Since the flow velocity is affected by viscosity, the water temperature too becomes the evaluation target as the reduced value subjected to monitoring.

Meanwhile, the analyzing unit 232 can monitor and analyze the demineralization rate of the RO membranes based on the measurement result obtained by the electricity conductivity meter. Generally, accompanying an increase in the pressure due to the blockage of the RO membranes, when the flow velocity is maintained, the demineralization rate of the RO membranes increases. Moreover, when there is deterioration of the RO membranes, the demineralization rate goes down. The demineralization rate is calculated based on the salt removal ratio (for example, the difference attributed to the electricity conductivity) of the RO membranes.

For example, according to the decrease in the demineralization rate under the same condition (the driving pressure or the flow velocity (the flow rate per unit area)), the analyzing unit 232 estimates (analyzes) the actual life-span (the remaining period of use) of the RO membranes.

### (Dosing Control Unit 233)

The dosing control unit 233 controls the dosing method (for example, the dosing timing and the dosage) of the chemicals, which are to be added into the reverse osmosis membrane device 120, based on the analysis result of the analyzing unit 232. The dosing control unit 233 controls the dosing device 122 according to the dosing method and thus controls, in an appropriate manner, the chemicals to be added into the reverse osmosis membrane device 120.

For example, regarding the vibrations explained earlier, it is believed that the characteristics of the vibrational frequency and the vibration velocity change according to the state of the RO membranes and the aging thereof. The analyzing unit 232 analyzes the two-dimensional behavior of the vibrations (i.e., the vibrational frequency and the vibration velocity); and the dosing control unit 233 varies the dosing (for example, the dosing ratio) of the chemicals according to the analysis result.

Generally, the RO membranes are cleaned two to four times a year using chemicals. For example, if the goal is not to perform chemical cleaning for six months so as to cut the cost, that is, if the goal is to perform chemical cleaning twice a year, then the RO membranes gradually become blocked on a weekly or monthly basis.

As the blockage progresses, the vibrational characteristics of the security filter 124, the second pump 121_2, and the third pump 121_3 undergo changes. The analyzing unit 232 analyzes the changes in the vibrational characteristics. According to the analysis result, the dosing control unit 233 suitably implements the dosing method (the dosing ratio or the dosing sequence) of, for example, an anti-scalant (an antifouling agent). In the case of intermittently adding the anti-scalant, the dosing sequence represents the on/off timing of dosing.

Meanwhile, the life-span (period of use) of an RO membrane is generally equal to 5 to 10 years. The analyzing unit 232 analyzes the changes in the vibrational characteristics according to the aging of the membranes. Then, according to the analysis result about the vibrational behavior according to the aging, the dosing control unit 233 optimizes the dosing method of the chemicals (for example, an anti-scalant).

In this way, for example, according to the physical quantities (for example, the vibrations, the water quality, and the pressure) of the pumps 121, the dosing control unit 233 controls the dosing method of the chemicals in an appropriate manner. As a result, the control device 200 becomes able to perform dosing control of the chemicals in a more appropriate manner. Thus, the control device 200 enables achieving reduction in the cost of the chemicals, and enables prolonging the period of use (life-span) of the RO membranes.

### (Pump Control Unit 234)

The pump control unit 234 controls the pumps 121. The pump control unit 234 controls the driving pressure of the pumps 121 in such a way that the water quantity of the reverse osmosis membrane device 120 is maintained at the set flow rate. For example, when the RO membranes get blocked, the flow rate of the reverse osmosis membrane device 120 goes down. For that reason, the pump control unit 234 performs PID control to increase the driving pressure of the pumps 121 in such a way that the reduced flow rate is restored to the set flow rate.

### 3. Example of Control Operation

### 3.1. Example of Control Operation According to Vibrations

As explained above, for example, the control device 200 controls the dosing of the chemicals according to the physical quantities of the pumps 121. Herein, the explanation is given about an example of a control operation in the case in which the control device 200 controls the dosing of the chemicals according to the vibrations of the pumps 121 representing a physical quantity of the pumps 121.

FIG. 4 is a diagram for explaining an example of the control operation performed according to the present embodiment.

The control device 200 obtains the vibration information related to the vibrations of the second pump 121_2 from the third vibration sensor 126_3 (Step S11). Moreover, the control device 200 obtains the vibration information related to the vibrations of the third pump 121_3 from the sixth vibration sensor 126_6 (Step S12). In this way, the control device 200 obtains the physical quantities of the pumps 121 (herein, the vibrations of the second pump 121_2 and the third pump 121_3).

The control device 200 analyzes the vibration information related to the obtained vibrations (Step S13). For example, the control device 200 analyzes the obtained vibration information, and predicts and detects the blockage condition of the RO membranes.

The control device 200 controls the dosing device 122 according to the analysis result (Step S14). For example, the control device 200 decides on the dosing method (the dosing timing and the dosage) according to the analysis result, and instructs (issues a control instruction about) the decided details to the dosing device 122.

In this way, according to the vibrations of the pumps 121, the control device 200 can control the dosing of the chemicals in a more appropriate manner.

### 3.2. Example of Control Operation According to Vibrations and Water Quality

In the example of the control operation explained above, the control device 200 performs control for adding the chemicals according to the vibrations of the pumps 121. Alternatively, the control device 200 can perform control for adding the chemicals according to the water quality of the pumps 121 in addition to (or in place of) referring to the vibrations of the pumps 121. That is, the control device can perform control for adding the chemicals according to the vibrations and the water quality of the pumps 121 representing physical quantities of the pumps 121.

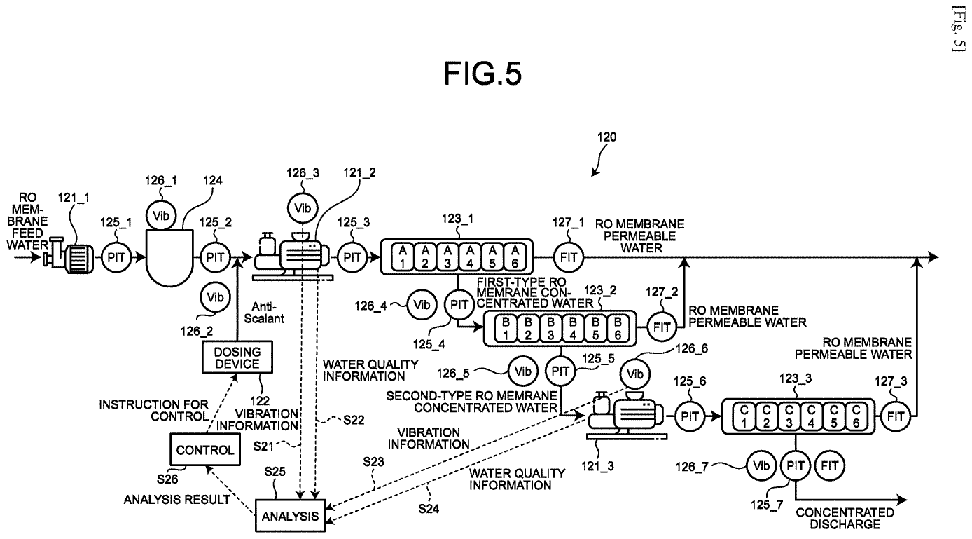

FIG. 5 is a diagram for explaining another example of the control operation performed according to the present embodiment.

The control device 200 obtains the vibration information related to the vibrations of the second pump 121_2 from the third vibration sensor 126_3 (Step S21). Moreover, the control device 200 obtains the water quality information related to the water quality of the second pump 121_2 (Step S22). The water quality information contains, for example, at least either the information related to the electricity conductivity or the information related to the water temperature. The control device 200 obtains the water quality information from, for example, the electricity conductivity meter (not illustrated) or the water temperature gauge (not illustrated) disposed in the second pump 121_2.

Furthermore, the control device 200 obtains the vibration information related to the vibrations of the third pump 121_3 from the sixth vibration sensor 126_6 (Step S23). Moreover, the control device 200 obtains the water quality information related to the water quality of the third pump 121_3 (Step S24). As explained above, the water quality information contains, for example, at least either the information related to the electricity conductivity or the information related to the water temperature. The control device 200 obtains the water quality from, for example, the electricity conductivity meter (not illustrated) or the water temperature gauge (not illustrated) disposed in the third pump 121_3.

In this way, the control device 200 obtains the physical quantities of the pumps 121 (herein, the vibrations and the water quality of the second pump 121_2 and the third pump 121_3).

The control device 200 analyzes the obtained vibration information related to the vibrations and the obtained water quality information related to the water quality (Step S25). For example, the control device 200 analyzes the vibration information and the water quality information that is obtained, and predicts and detects the blockage condition of the RO membranes.

According to the analysis result, the control device 200 controls the dosing device 122 (Step S26). For example, according to the analysis result, the control device 200 decides on the dosing method (the dosing timing and the dosage) of the chemicals and instructs (issues a control instruction about) the decided details to the dosing device 122.

In this way, the control device 200 can control, in a more appropriate manner, the dosing of the chemicals according to the vibrations and the water quality of the pumps 121.

### 3.3. Example of Control Operation According to Physical Quantities of Security Filter

In the examples of the control operation explained above, the control device 200 performs the dosing control of the chemicals according to the physical quantities of the pumps 121. Alternatively, the control device 200 can perform the dosing control of the chemicals according to the physical quantities of the security filter 124. That is, the control device 200 can perform control for adding the chemicals according to the physical quantities of the security filter 124 in addition to (or in place of) referring to the physical quantities of the pumps 121.

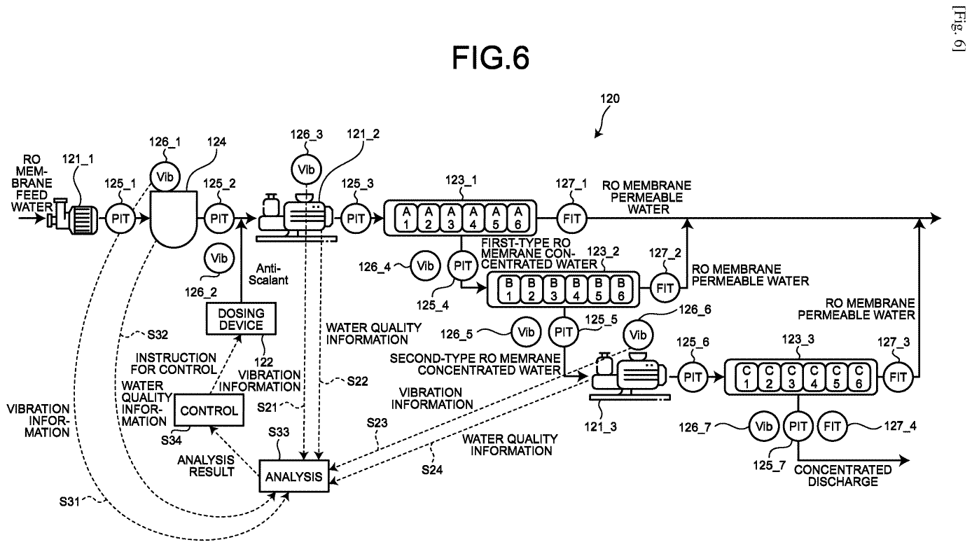

FIG. 6 is a diagram for explaining another example of the control operation according to the present embodiment. The operations identical to the operations illustrated in FIG. 5 are referred to by the same step numbers, and their explanation is not repeated.

The control device 200 obtains the vibration information related to the vibrations of the security filter 124 from the first vibration sensor 126_1 (Step S31). Moreover, the control device 200 obtains the water quality information related to the water quality of the security filter 124 (Step S32). Herein, the water quality information contains, for example, at least either the information related to the electricity conductivity or the information related to the water temperature. The control device 200 obtains the water quality information from, for example, the electricity conductivity meter (not illustrated) or the water temperature gauge (not illustrated) disposed in the security filter 124.

In this way, the control device 200 obtains the physical quantities (herein, the vibrations and the water quality) of the pumps 121 (herein, the second pump 121_2 and the third pump 121_3) and the security filter 124.

The control device 200 analyzes the obtained vibration information related to the vibrations and the obtained water quality information related to the water quality (Step S33). For example, the control device 200 analyzes the vibration information and the water quality information that is obtained, and predicts and detects the blockage condition of the security filter 124 and the RO membranes.

The control device 200 controls the dosing device 122 according to the analysis result (Step S34). For example, according to the analysis result, the control device 200 decides on the dosing method (the dosing timing and the dosage) of the chemicals, and instructs (issues a control instruction about) the decided details to the dosing device 122.

In this way, according to the vibrations and the water quality of the pumps 121 and the security filter 124, the control device 200 becomes able to control the dosing of the chemicals in a more appropriate manner.

### 3.4. Flow of Control Operation

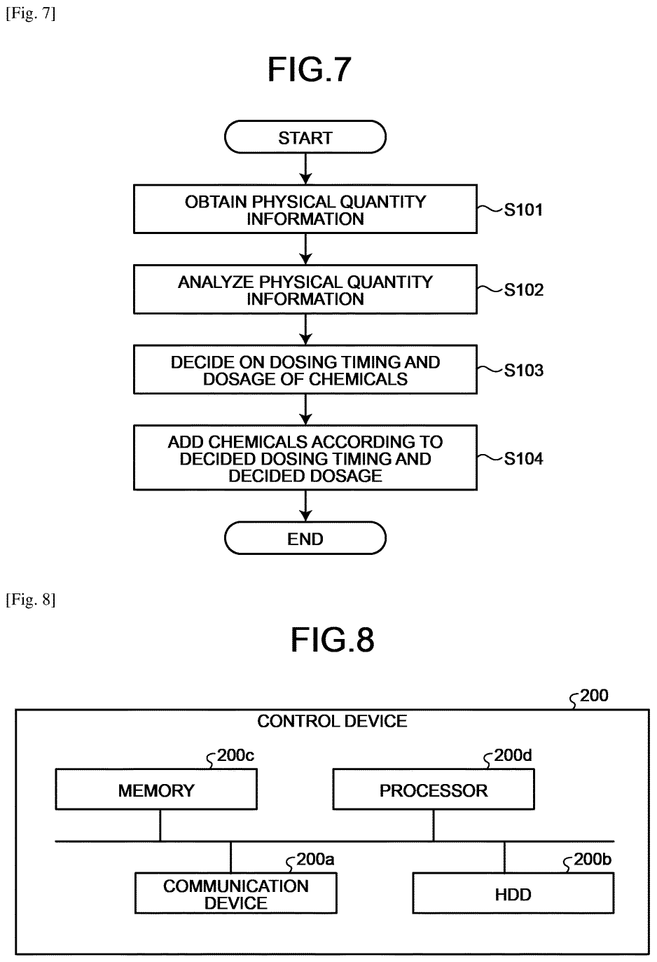

FIG. 7 is a flowchart for explaining an exemplary flow of the control operation performed according to the present embodiment. The control operation illustrated in FIG. 7 is repeatedly performed by the control device 200 while the water treatment system 10 is performing water treatment.

As illustrated in FIG. 7, the control device 200 obtains the physical quantity information from the water treatment device 100 (Step S101). For example, the control device 200 obtains the physical quantity information about the pumps 121 and the security filter 124. The physical quantity information contains, for example, the vibration information.

Then, the control device 200 analyzes the obtained physical quantity information (Step S102). Based on the analysis result, the control device 200 decides on the dosing timing and the dosage of the chemicals (Step S103).

The control device 200 adds the chemicals according to the decided dosing timing and the decided dosage (Step S104). More particularly, the control device 200 controls the dosing device 122 to add chemicals according to the decided dosage.

Meanwhile, herein, the control device 200 obtains the physical quantity information from the water treatment device 100. In addition to obtaining the physical quantity information, the control device 200 can also obtain the water quality information. In that case, the control device 200 controls the dosing timing and the dosage of the chemicals based on the physical quantity information and the water quality information.

In this way, the control device 200 according to the present embodiment controls the dosing of the chemicals into the reverse osmosis membrane device 120 based on the physical quantities of the pumps 121. As a result, the control device 200 becomes able to control the dosing of the chemicals into the reverse osmosis membrane device 120 in a more appropriate manner.

### 4. System

The processing procedures, the control procedures, specific names, various data, and information including parameters described in the embodiment or illustrated in the drawings can be changed as required unless otherwise specified.

The constituent elements of the device illustrated in the drawings are merely conceptual, and need not be physically configured as illustrated. The constituent elements, as a whole or in part, can be separated or integrated either functionally or physically based on various types of loads or use conditions.

The process functions implemented in the device are entirely or partially implemented by a CPU or by computer programs that are analyzed and executed by a CPU, or are implemented as hardware by wired logic.

### 5. Hardware

Given below is the explanation of an exemplary hardware configuration of the control device 200 that is an information processing device. FIG. 8 is a diagram for explaining an exemplary hardware configuration of the control device 200. As illustrated in FIG. 8, the control device 200 includes a communication device 200a, an HDD (Hard Disk Drive 200b), a memory 200c, and a processor 200d. Moreover, the constituent elements illustrated in FIG. 8 are connected to each other by a bus.

The communication device 200a is a network interface card that performs communication with other servers. The HDD 200b is used to store programs and databases meant for implementing the functions illustrated in FIG. 3.

The processor 200d reads a program, which is written for executing the operations identical to the processing units illustrated in FIG. 3, from the HDD 200b and loads it in the memory 200c. As a result, a process is run that is meant for implementing the functions explained with reference to FIG. 4. For example, the process implements functions identical to the processing units included in the control device 200. More particularly, the processor 200d reads, from the HDD 200b, a program that is equipped with identical functions to the obtaining unit 231, the analyzing unit 232, the dosing control unit 233, and the pump control unit 234. Then, the processor 200d executes a process that implements the operations identical to the obtaining unit 231, the analyzing unit 232, the dosing control unit 233, and the pump control unit 234.

In this way, the control device 200 operates as a device that reads and executes a program and implements various processing methods. Alternatively, the control device 200 can read the abovementioned program from a recording medium using a medium reading device, execute the read program, and implement the functions identical to the embodiment described above. Meanwhile, the program according to the present embodiment is not limited to be executed by the control device 200. For example, even when some other computer or a server executes the program or when such devices execute the program in cooperation, the present invention can still be applied in an identical manner.

Still alternatively, the abovementioned program can be distributed via a network such as the Internet. Still alternatively, the abovementioned program can be recorded in a computer-readable recording medium such as a hard disk, a flexible disk (FD), a CD-ROM, an MO (Magneto-Optical disk), or a DVD (Digital Versatile Disc). Thus, a computer can read the program from the recording medium and execute it.

### 6. Miscellaneous

Given below is the explanation of some combinations of the technical features disclosed herein.
(1)

A control device comprising:
an obtaining unit that obtains a physical quantity of a pump which is meant for pumping treatment water into a reverse osmosis membrane device; and
a control unit that controls dosing of chemical into the treatment water according the physical quantity of the pump, wherein
the chemical prevents blockage in the reverse osmosis membrane device.
(2)

The control device according to (1), wherein
the obtaining unit obtains water quality information related to water quality of the treatment water in the pump, and
according to the water quality information about inside of the pump, the control unit controls the dosing of the chemical into the treatment water.
(3)

The control device according to (1) or (2), wherein
the obtaining unit obtains at least either physical quantity information related to physical quantity of a security filter or water quality information related to water quality of the security filter, and
according to at least either the physical quantity information of the security filter or the water quality information of the security filter, the control unit controls the dosing of the chemical into the treatment water.
(4)

The control device according to (1) or (3), wherein the physical quantity represents at least either vibration of the pump, or water quantity of the pump, or water pressure of the pump.
(5)

The control device according to (2) or (3), wherein the water quality information contains at least either electricity conductivity or water temperature.
(6)

The control device according to any one of (1) to (5), wherein the control unit controls at least either timing of adding the chemical or dosage of the chemical.
(7)

The control device according to any one of (1) to (6), wherein the control unit analyzes the physical quantity and controls the dosing of the chemical.
(8)

The control device according to any one of (1) to (7), wherein the pump is at least either a high-pressure pump or a booster pump meant for supplying the treatment water to the reverse osmosis membrane device.
(9)

A control method implemented in a computer, comprising:
obtaining a physical quantity of a pump which is meant for pumping treatment water into a reverse osmosis membrane device; and controlling dosing of chemical into the treatment water according the physical quantity of the pump, wherein
the chemical prevents blockage in the reverse osmosis membrane device.
(10)

A control program that causes a computer to execute:
obtaining a physical quantity of a pump which is meant for pumping treatment water into a reverse osmosis membrane device; and
controlling dosing of chemical into the treatment water according the physical quantity of the pump, wherein
the chemical prevents blockage in the reverse osmosis membrane device.

### REFERENCE SIGNS LIST

10 water treatment system
100 water treatment device
110 membrane filtration device
120 reverse osmosis membrane device
121 pump
122 dosing device
124 security filter
125 pressure sensor
126 vibration sensor
127 flow rate sensor
130 UV treatment device
200 control device
210 communication unit
220 memory unit
230 control unit
231 obtaining unit
232 analyzing unit
233 dosing control unit
234 pump control unit

1. A control device comprising:
a processor configured to:
obtain a physical quantity of a pump which is meant for pumping treatment water into a reverse osmosis membrane device; and
control dosing of chemical into the treatment water according the physical quantity of the pump, wherein
the chemical prevents blockage in the reverse osmosis membrane device.

2. The control device according to claim 1, wherein
the processor is further configured to:
obtain water quality information related to water quality of the treatment water in the pump, and
according to the water quality information about inside of the pump, the control unit control the dosing of the chemical into the treatment water.

3. The control device according to claim 1, wherein
the processor is further configured to:
obtain at least either physical quantity information related to physical quantity of a security filter or water quality information related to water quality of the security filter, and
according to at least either the physical quantity information of the security filter or the water quality information of the security filter, control the dosing of the chemical into the treatment water.

4. The control device according to claim 1, wherein the physical quantity represents at least either vibration of the pump, or water quantity of the pump, or water pressure of the pump.

5. The control device according to claim 2, wherein the water quality information contains at least either electricity conductivity or water temperature.

6. The control device according to claim 1, wherein the processor is further configured to control at least either timing of adding the chemical or dosage of the chemical.

7. The control device according to claim 1, wherein the processor is further configured to analyze the physical quantity and controls the dosing of the chemical.

8. The control device according to claim 1, wherein the pump is at least either a high-pressure pump or a booster pump meant for supplying the treatment water to the reverse osmosis membrane device.

9. A control method computer, comprising:
obtaining a physical quantity of a pump which is meant for pumping treatment water into a reverse osmosis membrane device; and
controlling dosing of chemical into the treatment water according the physical quantity of the pump, wherein
the chemical prevents blockage in the reverse osmosis membrane device, using a processor.

10. A non-transitory computer-readable recording medium having stored therein a control program that causes a computer to execute:
obtaining a physical quantity of a pump which is meant for pumping treatment water into a reverse osmosis membrane device; and
controlling dosing of chemical into the treatment water according the physical quantity of the pump, wherein
the chemical prevents blockage in the reverse osmosis membrane device.
